(19) United States
(12) Patent Application Publication
(10) Pub. No.: US 2023/0077187 A1
(43) Pub. Date: Mar. 9, 2023

(54) Three-Dimensional Facial Reconstruction

(71) Applicant: Huawei Technologies Co., Ltd., Shenzhen (CN)

(72) Inventors: Stefanos Zafeiriou, London (GB); Alexandros Lattas, London (GB); Stylianos Moschoglou, London (GB); Stylianos Ploumpis, London (GB); Baris Gecer, London (GB)

(21) Appl. No.: 17/800,951

(22) PCT Filed: Feb. 20, 2021
(86) PCT No.: PCT/CN2021/077021

§ 371 Date: Aug. 19, 2022

(30) Foreign Application Priority Data
Feb. 21, 2020 (GB) 2002449.3

(51) Int. Cl. G06T 15/20; G06T 3/40; G06N 3/04

(52) U.S. Cl. CPC G06T 15/205; G06T 3/4053; G06T 3/4046; G06N 3/0454; G06T 2200/08

(57) ABSTRACT

A computer implemented method of generating a three-dimensional facial rendering from a two-dimensional image having a facial image includes: generating a three-dimensional shape model of the facial image and a low resolution two-dimensional texture map of the facial image from the two-dimensional image using a fitting neural network; applying a super-resolution model to the low resolution two-dimensional texture map to generate a high resolution two-dimensional texture map; generating a two-dimensional diffuse albedo map from the high resolution texture map using a de-lighting image-to-image translation neural network; and rendering a high resolution three-dimensional model of the facial image using the two-dimensional diffuse albedo map and the three dimensional shape model.

This application claims the benefit of priority of U.K. Patent Application No. GB2002449.3, filed Feb. 21, 2020 and entitled “Three-dimensional Facial Reconstruction”, the contents of which are hereby incorporated by reference as if reproduced in its entirety.

### FIELD

This specification describes methods and systems for reconstructing three-dimensional facial models from two-dimensional images of faces.

### BACKGROUND

Reconstruction of the three-dimensional (3D) face and texture from two-dimensional (2D) images is one of the most popular and well-studied fields in the intersection of computer vision, graphics and machine learning. This is not only due to its countless applications, but also to show-case the power of the recent developments in learning, inference and synthesizing of the geometry of 3D objects. Recently, mainly due to the advent of deep learning, tremendous progress has been made in the reconstruction of a smooth 3D face geometry even from 2D images captured in arbitrary recording conditions (also referred to as “in-the-wild”).

Nevertheless, even though the geometry can be inferred somewhat accurately, the quality of textures generated remain unrealistic, with the 3D facial renders produced by current methods often lacking detail and falling into the “uncanny valley”.

### SUMMARY

According to a first aspect, this specification discloses a computer implemented method of generating a three-dimensional facial rendering from a two dimensional image comprising a facial image. The method comprises: generating a three-dimensional shape model of the facial image and a low resolution two-dimensional texture map of the facial image from the two-dimensional image using one or more fitting neural networks; applying a super-resolution model to the low resolution two-dimensional texture map to generate a high resolution two-dimensional texture map; generating a two-dimensional diffuse albedo map from the high resolution texture map using a de-lighting image-to-image translation neural network; and rendering a high resolution three-dimensional model of the facial image using the two-dimensional diffuse albedo map and the three dimensional shape model.

The two-dimensional diffuse albedo map may be a high resolution two-dimensional diffuse albedo map.

The method may further comprise: determining a two-dimensional normal map of the facial image from the three-dimensional shape model, wherein the two-dimensional diffuse albedo map is generated additionally using the two-dimensional normal map.

The method may further comprise: generating, using a specular albedo image-to-image translation neural network, a two-dimensional specular albedo map from the two-dimensional diffuse albedo map, wherein rendering the high resolution three dimensional model of the facial image is further based on the two-dimensional specular albedo map. The method may further comprise: generating a grey-scale two-dimensional diffuse albedo map from the two-dimensional diffuse albedo map; and inputting the grey-scale two-dimensional diffuse albedo map into the specular albedo image-to-image translation neural network. The method may further comprise: determining a two-dimensional normal map of the facial image from the three-dimensional shape model, wherein the two-dimensional specular albedo map is additionally generated from the two-dimensional normal map using the specular albedo image-to-image translation neural network.

The method may further comprise: determining a two-dimensional normal map of the facial image from the three-dimensional shape model; and generating, using a specular normal image-to-image translation neural network, a two-dimensional specular normal map from the two-dimensional diffuse albedo map and the two-dimensional normal map, wherein rendering the high resolution three dimensional model of the facial image is further based on the two-dimensional specular normal map. Generating, using the specular normal image-to-image translation neural network, the two-dimensional specular normal map may comprise: generating a grey-scale two-dimensional diffuse albedo map from the two-dimensional diffuse albedo map; and inputting the grey-scale two-dimensional diffuse albedo map and the two-dimensional normal map into the specular normal image-to-image translation neural network.

The two-dimensional normal map may be a two-dimensional normal map in tangent space. Generating the two-dimensional normal map in tangent space from the three-dimensional shape model may comprise: generating a two-dimensional normal map in object space from the three-dimensional shape model; and applying a high pass filter to the two-dimensional normal map in object space.

The method may further comprise: determining a two-dimensional normal map in object space of the facial image from the three-dimensional shape model; and generating, using a diffuse normal image-to-image translation neural network, a two-dimensional diffuse normal map from the two-dimensional diffuse albedo map and two-dimensional normal map in tangent space, wherein rendering the high resolution three dimensional model of the facial image is further based on the two-dimensional diffuse normal map. Generating, using a diffuse normal image-to-image translation neural network, a two-dimensional diffuse normal map may comprise: generating a grey-scale two-dimensional diffuse albedo map from the two-dimensional diffuse albedo map; and inputting the grey-scale two-dimensional diffuse albedo map and the two-dimensional normal map in tangent space into the diffuse normal image-to-image translation neural network.

The method further may further comprise, for each image-to-image translation neural network: dividing the input two-dimensional maps into a plurality of overlapping input patches; generating, for each of the input patches, an output patch using the image-to-image translation neural network; and generating a full output two-dimensional map by combining the plurality of output patches.

The fitting neural network and/or the image-to-image translation networks may be generative adversarial networks.

The method may further comprise generating a three-dimensional model of a head from the high resolution three dimensional model of the facial image using a combined face and head model.

One or more of the two-dimensional maps may comprise a W map.

According to a further aspect, this specification discloses a system comprising one or more processors and a memory, the memory comprising computer readable instructions that, when executed by the one or more processors, cause the system to perform any one or more of the methods disclosed herein.

According to a further aspect, this specification discloses a computer program product comprising computer readable instructions that, when executed by a computing system, cause the computing system to perform any one or more of the methods disclosed herein.

### BRIEF DESCRIPTION OF THE DRAWINGS

Embodiments will now be described by way of non-limiting examples with reference to the accompanying drawings, in which:

FIG. 1 shows a schematic overview of an example method of generating a three-dimensional facial rendering from a two dimensional image;

FIG. 2 shows a flow diagram of an example method of generating a three-dimensional facial rendering from a two dimensional image;

FIG. 3 shows a schematic overview of a further example method of generating a three-dimensional facial rendering from a two dimensional image;

FIG. 4 shows a schematic overview of an example method of training an image-to-image neural network; and

FIG. 5 shows a schematic example of a system/apparatus for performing any of the methods described herein.

### DETAILED DESCRIPTION

To achieve photorealistic rendering of the human skin, diffuse reflectance (albedo) is modelled. Given a low resolution 2D texture map (e.g. a UV map) and a base geometry reconstructed from a single unconstrained face image as input, a Diffuse Albedo, A_{D}, is inferred by applying a super-resolution model to the low resolution 2D texture map to generate a high resolution texture map, followed by a de-lighting network to obtain a high resolution Diffuse Albedo. The diffuse albedo shows the colour of light “emitted” by the skin. The diffuse albedo, high resolution texture map and base geometry may be used to render a high quality 3D facial model. Other components (e.g., Diffuse Normals, Specular Albedo, and/or Specular Normals) may be inferred from the Diffuse Albedo in conjunction with the base geometry, and used to render the high quality 3D facial model.

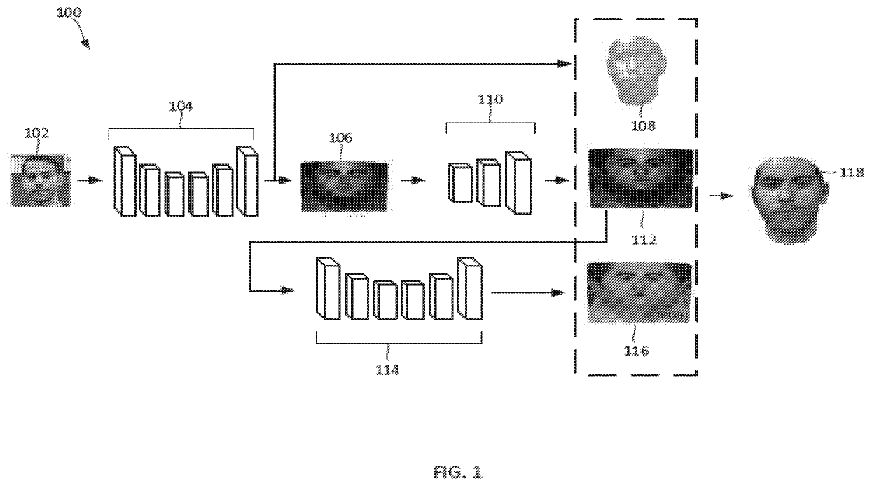

FIG. 1 shows a schematic overview of an example method 100 of generating a three-dimensional facial rendering from a two dimensional image. The method may be implemented on a computer. A 2D image 102 comprising a face is input into one or more fitting neural networks 104, which generate a low resolution 2D texture map 106 of the textures of the face and a 3D model 108 of the geometry of the face. A super resolution model 110 is applied to the low resolution 2D texture map 106 in order to upscale the low resolution 2D texture map 106 into a high resolution 2D texture map 112. A 2D diffuse albedo map 116 is generated from the high resolution 2D texture map 112 using an image-to-image translation neural network 114 (also referred to herein as a “de-lighting image-to-image translation network”). The 2D diffuse albedo map 116 is used to render the 3D model 108 of the geometry of the face to generate a high resolution 3D model 118 of the face in the input image 102.

The input 2D image 102, I, comprises a set of pixel values in an array. For example, in a colour image I∈ [symbol] ^{H×W×3}, where H is the height of the image in pixels, W is the width of the image in pixels and the image has three colour channels (e.g. RGB or CIELAB). Alternatively, the input 2D image 102 may be in black-and-white or greyscale. The input image may be cropped from a larger image based on detection of a face in the larger image.

The one or more fitting neural networks 104 generates the 3D facial shape 108, S∈ [symbol] ^{N×3}, and the low resolution 2D texture map 106, T∈ [symbol] ^{H}^{_{LR}}^{×W}^{_{LR}}^{×3}, where N is the number of vertices in the 3D facial shape mesh, and H_{LR} and W_{LR} are the height and width of the low resolution 2D texture map 106 respectively. In some embodiments a single fitting neural network is used to generate both the 3D facial shape 108 and the low resolution 2D texture map 106. This may be represented symbolically as:

T,S= [symbol] (I)

where [symbol] : [symbol] ^{H×W×3}→ [symbol] ^{H}^{_{LR}}^{×W}^{_{LR}}^{×3}, [symbol] ^{N×3} is the fitting neural network. The fitting neural network may be based on a Generative Adversarial Network (GAN) architecture. An example of such a network is described in “GANFIT: Generative Adversarial Network Fitting for High Fidelity 3D Face Reconstruction” (B. Gecer et al., Proceedings of the IEEE Conference on Computer Vision and Pattern Recognition, pages 1155-1164, 2019), the contents of which are hereby incorporated by reference. However, any neural network or model trained to fit a 3D facial shape 108 to an image and/or generate a 2D texture map from a 2D image 102 may be used. In some embodiments, separate fitting neural networks are used to generate each of the 3D facial shape 108 and the low resolution 2D texture map 106.

The low resolution 2d texture map 106 may be any 2D map that can represent 3D textures. An example of such a map is a UV map. A UV map is a 2D representation of a 3D surface or mesh. Points in 3D space (for example described by (x, y, z) co-ordinates) are mapped onto a 2D space (described by (u, v) co-ordinates). A UV map may be formed by unwrapping a 3D mesh in a 3D space onto the u-v plane in the 2D UV space, and storing parameters associated with the 3D surface at each point in UV space. A texture UV map 110 may be formed by storing colour values of the vertices of a 3D surface/mesh in the 3D space at corresponding points in the UV space.

The super resolution model 110 takes as input the low resolution texture map 106, T∈ [symbol] ^{H}^{_{LR}}^{×W}^{_{LR}}^{×3}, and generates a high resolution texture map 112, \hat{T}∈ [symbol] ^{H}^{_{HR}}^{×W}^{_{HR}}^{×3}, from it, where H_{HR} and W_{HR} are the height and width of the high resolution 2D texture map 112 respectively, with H_{HR}>H_{LR} and W_{HR}>W_{LR}. This may be represented symbolically as:

\hat{T}=ζ(T)

where ζ: [symbol] ^{H×W×3}→ [symbol] ^{H}^{_{LR}}^{×W}^{_{LR}}^{×3}, [symbol] ^{N×3} is the super resolution model. The super resolution model 100 may be a neural network. The super resolution model 110 may be a convolutional neural network. An example of such a super-resolution neural network is RCAN, described in “Image super-resolution using very deep residual channel attention networks” (Y. Zhang et al., Proceedings of the European Conference on Computer Vision (ECCV), pages 286-301, 2018), the contents of which are hereby incorporated by reference, though any example of a super resolution neural network may be used. The super resolution neural network may be trained on data comprising low resolution texture maps each with a corresponding high resolution texture map.

The high resolution 2d texture map 112 may be any 2D map that can represent 3D textures, such as a UV map (as described above in relation to the low resolution 2d texture map 106).

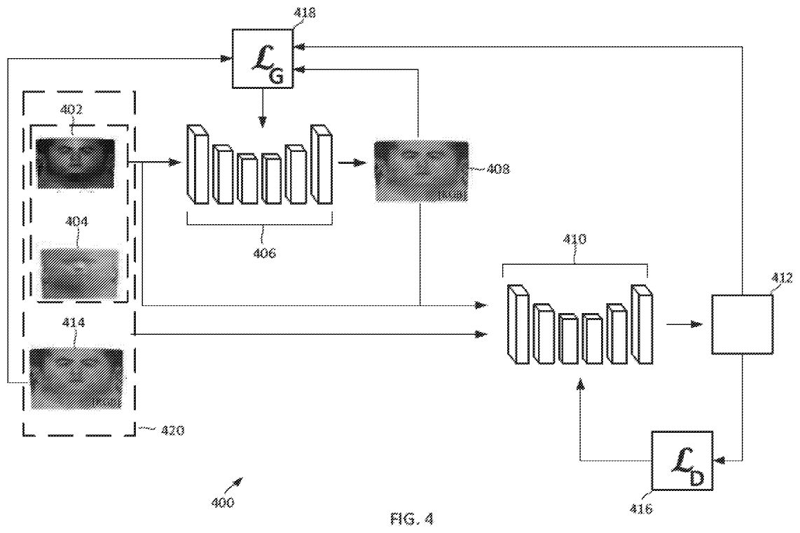

The de-lighting image-to-image translation network 114 takes as input the high resolution texture map 112, \hat{T}∈ [symbol] ^{H}^{_{HR}}^{×W}^{_{HR}}^{×3}, and generates a 2D diffuse albedo map 116, A_{D}∈ [symbol] ^{H}^{_{D}}^{×W}^{_{D}}^{×3} from it, where H_{D} and W_{D} are the height and width of the high resolution 2D diffuse albedo map 116 respectively. Typically, low resolution textures generated by fitting neural networks contain baked illumination (e.g. reflection, shadows) as the fitting neural network has been trained on a vast dataset of subjects captured under near-constant illumination, produced by environment lighting and three point-light sources. Thus, the captures contain sharp highlights and shadows which prohibit photorealistic rendering. The delighting neural network may be pre-trained to generate un-lit diffuse albedos from the high resolution texture map 112, as described below in relation to FIG. 4.

The delighting image-to-image translation network 116 may be represented symbolically as:

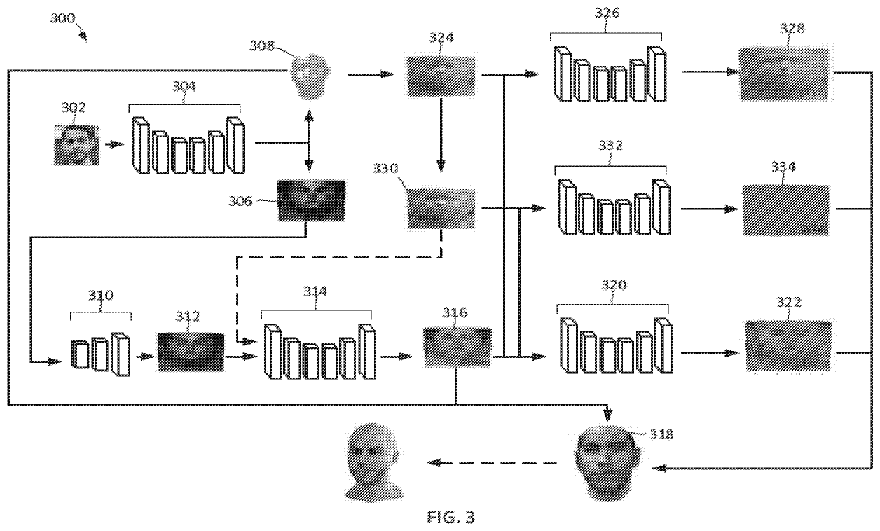

A_{D}=δ(\hat{T})

where δ→ [symbol] ^{H}^{_{HR}}^{×W}^{_{HR}}^{×3}→ [symbol] ^{H}^{_{D}}^{×W}^{_{D}}^{×3}. In some embodiments, a 2D normal map derived from the 2D input image may additionally be input into the delighting image-to-image translation network 116, as described below in relation to FIG. 3. In some embodiments, the high resolution 2D texture map 112 map be normalised to the range [−1,1] before being input into the delighting image-to-image translation network 116 (along with the 2D normal map, in embodiments where it is used). The normalised high resolution texture may be denoted A_{D}^{T}.

Image-to-image translation refers to the task of translating an input image to a designated target domain (e.g., turning sketches into images, or day into night scenes). Image-to image translation typically utilises a Generative Adversarial Network (GAN) conditioned on an input image. The image-to-image translation networks (e.g. the delighting/specular albedo/diffuse normal/specular normal image-to-image translation networks) disclosed herein may utilise such a GAN. The GAN architecture comprises a generator network configured to generate a transformed image from an input image, and a discriminator network configured to determine whether the transformed image is plausible transformation of the input image. The generator and discriminator are trained in an adversarial manner; the discriminator is trained with the aim of distinguishing transformed images from corresponding ground truth images, while the generator is trained with the aim of generating transformed images to fool the discriminator. Examples of training image-to-image translation networks are described below in relation to FIG. 4.

An example of an image-to-image translation network is pix2pixHD, details of which can be found in “High-Resolution Image Synthesis and Semantic Manipulation with Conditional GANs” (T. C. Wang et al., Proceedings of the IEEE conference on computer vision and pattern recognition, pages 8798-8807, 2018), the contents of which are hereby incorporated by reference. Variations of pix2pixHD can be trained to carry out tasks such as de-lighting as well as the extraction of the diffuse and specular components in super high-resolution data. The pix2pixHD network may be modified to take as input an input 2D map and a shape normal map. The pix2pixHD network may have nine residual blocks in the global generators. The pix2pixHD network may have three residual blocks in the local generators.

The 2D diffuse albedo map 116 is used to render the 3D model 108 of the geometry of the face to generate a high resolution 3D model 118 of the face in the input image 102. The 2D diffuse albedo map 116 may be relit using any lighting environment in order to render the 3D model 118 under different lighting conditions.

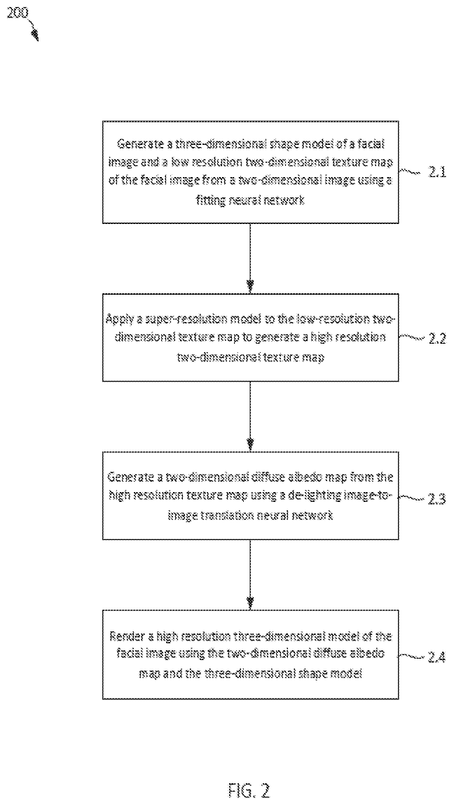

FIG. 2 shows a flow diagram of an example method 200 of generating a three-dimensional facial rendering from a two dimensional image. The method may be implemented on a computer.

At operation 2.1, a 3D shape model of a facial image and a low resolution 2D texture map of the facial image are generated from a 2D image using one or more fitting neural networks. The fitting neural networks may be a generative adversarial network.

In some embodiments, one or more 2D normal maps of the facial image may be generated from the 3D shape model. The one or more 2D normal maps may comprise a normal map in object space and/or a normal map in tangent space. The normal map in tangent space may be generated by applying a high-pass filter to the normal map in object space.

At operation 2.2, a super-resolution model is applied to the low-resolution 2D texture map to generate a high resolution 2D texture map. The super resolution model may be a super-resolution neural network. The super resolution neural network may comprise one or more convolutional layers.

At operation 2.3, a 2D diffuse albedo map is generated from the high resolution texture map using a de-lighting image-to-image translation neural network. The 2D diffuse albedo map may be a high resolution 2D diffuse albedo map. The de-lighting image-to-image translation neural network may be a GAN. The 2D diffuse albedo map may be generated additionally using a 2D normal map.

One or more further 2D maps may also be generated using corresponding image-to-image translation networks.

A specular albedo image-to-image translation neural network may be used to generate a 2D specular albedo map from the 2D diffuse albedo map (or a greyscale version of the 2D diffuse albedo map). The 2D specular albedo map may additionally be generated from a 2D normal map using the specular albedo image-to-image translation neural network, i.e. a 2D normal map and the 2D diffuse albedo map may be input into the specular albedo image-to-image translation neural network.

A diffuse normal image-to-image translation neural network may be used to generate a 2D diffuse normal map from the 2D diffuse albedo map (or a greyscale version of the 2D diffuse albedo map) and a 2D normal map in tangent space.

A specular normal image-to-image translation neural network may be used to generate a two-dimensional specular normal map from the two-dimensional diffuse albedo map (or a greyscale version of the 2D diffuse albedo map) and a two-dimensional normal map.

At operation 2.4, a high resolution 3D model of the facial image is rendered using the 2D diffuse albedo map and the 3D shape model. The one or more further texture maps may also be used to render the 3D model of the facial image. A three-dimensional model of a head may be generated from the high resolution three dimensional model of the facial image using a combined face and head model. Different lighting environments may be applied to the 2D diffuse albedo map during the rendering process.

FIG. 3 shows a schematic overview of a further example method 300 of generating a three-dimensional facial rendering from a two dimensional image. The method may be implemented on a computer. The method 300 begins as described in FIG. 1: a 2D image 302 comprising a face is input into one or more fitting neural networks 304, which generate a low resolution 2D texture map 306 of the textures of the face and a 3D model 308 of the geometry of the face. A super resolution model 310 is applied to the low resolution 2D texture map 306 in order to upscale the low resolution 2D texture map 306 into a high resolution 2D texture map 312. A 2D diffuse albedo map 316 is generated from the high resolution 2D texture map 112 using an image-to-image translation neural network 314.

The 3D model 308 of the geometry of the face can be used to generate one or more 2D normal maps 324, 330 of the face. A 2D normal map in object space 324 may be generated directly from the 3D model 308 of the geometry of the face. A high-pass filter may be applied to the 2D normal map in object space 324 to generate a 2D normal map in tangent space 324. Normals may be calculated per-vertex of the 3D model as the perpendicular vectors to two vectors of a ‘face’ (e.g. triangle) of the 3D mesh. The normals may be stored in image format using a UV map parameterisation. Interpolation may be used to create a smooth normal map.

One or more of the 2D normal maps 324, 330 may, in some embodiments, be input into the diffuse albedo image-to-image network 314 in addition to the high resolution texture map 312 when generating the diffuse albedo map 316. In particular, the 2D normal map in tangent space 324 may be input. The 2D normal map 324, 330 used may be concatenated with the high resolution texture map 312 (or its normalised version) and input into the diffuse albedo image-to-image network 314. Including a 2D normal map 324, 330 n the input van reduce variations in redacted shadows in the output diffuse albedo map 316. Since occlusion of illumination on the skin surface is geometry-dependent, the albedo map improves in quality when feeding the network with both the texture and geometry of the 3DMM. The shape normals may act as a geometric “guide” for the image-to-image translation networks.

Further 2D maps may be generated from the 2D diffuse albedo map 316. One example is a specular albedo map 322, which may be generated from the diffuse albedo map 316 using a specular albedo image-to-image translation neural network 320. The specular albedo 322 acts as a multiplier to the intensity of reflected light, regardless to colour. The specular albedo 322 is defined by the composition and roughness of the ski. As such, its values can be inferred by differentiating between skin parts (e.g., facial hair, bare skin).

In principle, specular albedo can be computed from the texture with the baked illumination, as long as the texture includes baked specular light. However, the specular component derived using such a method may be strongly biased due to environment illumination and occlusion. Inferring the specular albedo from the diffuse albedo can result in a higher quality specular albedo map 322.

To generate the specular albedo map 322, Aₛ, the diffuse albedo map 316 is input into an image-to-image translation network 320. The diffuse albedo 316 map may be pre-processed before being input to the image-to-image translation network 320. For example, the diffuse albedo map 316 may be converted to greyscale diffuse albedo map, A_{D}^{gray} (e.g. using

$${A}_{D}^{g r a y} = {\sum }_{R G B} {A}_{D} / 3 ) .$$

In some embodiments, a shape normal map (such as a shape normal map in object space, N_{O}) is also input into the image-to-image translation network 320.

The specular albedo image-to-image translation network 320 processes its inputs through a plurality of layers and outputs a specular albedo map 322. In embodiments where only the diffuse albedo map is used, the process may be represented symbolically as:

Aₛ=ψ(A_{D}).

In embodiments where a shape normal map in object space is also input and the diffuse albedo map is converted to greyscale, this may be represented symbolically as:

Aₛ=ψ(A_{D}^{gray},N_{O})

where: A_{D}^{gray},N_{O}→Aₛ∈ [symbol] ^{H}^{ₛ}^{×W}^{ₛ}^{×3}, with Hₛ and Wₛ the height and width of the specular albedo map 112 respectively. In some embodiments, Hₛ and Wₛ are equal to H_{D} and W_{D} respectively. The generated 2D specular albedo map 322 may be a UV map.

The generated 2D specular albedo map 322 is used to render the 3D facial model 318, along with the diffuse albedo map 316 and the 3D model 308 of the geometry of the face.

Alternatively or additionally, a diffuse normal map 328 may be generated using a diffuse normal image-to-image translation network 326. Diffuse normals are highly correlated with the shape normals, as diffusion is scattered uniformly across the skin. Scars and wrinkles alter the distribution of the diffusion and some non-skin features such as hair that produce much less subsurface scattering.

To generate the diffuse normal map 328, N_{D}, the diffuse albedo map 316 is input into an image-to-image translation network 326 along with a shape normal map 324,330. The diffuse albedo 316 map may be pre-processed before being input to the image-to-image translation network 320. For example, the diffuse albedo map 316 may be converted to greyscale diffuse albedo map, as described above in relation to the specular albedo map 322. The shape normal map may be the shape normal map in object space 324, N_{O}.

The diffuse normal image-to-image translation network 326 processes its inputs through a plurality of layers and outputs a diffuse normal map 328. In embodiments where a shape normal map in object space is input and the diffuse albedo map is converted to greyscale, this may be represented symbolically as:

N_{D}=σ(A_{D}^{gray},N_{O})

where: A_{D}^{gray},N_{O}→N_{D}∈ [symbol] ^{H}^{_{ND}}^{×W}^{_{ND}}^{×3}, with H_{ND} and W_{ND} the height and width of the diffuse normal map 328 respectively. In some embodiments, H_{ND} and W_{ND} are equal to H_{D} and W_{D} respectively. The generated 2D diffuse normal map 328 may be a UV map.

The generated 2D diffuse normal map 328 is used to render the 3D facial model 318, along with the diffuse albedo map 316 and the 3D model 308 of the geometry of the face. The 2D specular albedo map 322 may additionally be used.

Alternatively or additionally, a specular normal map 334 may be generated using a specular normal image-to-image translation network 332. The specular normals exhibit sharp surface details such as fine wrinkles and skin pores, and are challenging to estimate as some high-frequency details do not appear in the illuminated texture or the estimated diffuse albedo. While the high resolution texture map 312 may be used to generate the specular normal map 334, it includes sharp highlights that may get wrongly interpreted as facial features by the network. The diffuse albedo, even though it is striped from specular reflection, contains texture information that defines medium-frequency and high-frequency details, such as pores and wrinkles. To generate the specular normal map 334, Nₛ, the diffuse albedo map 316 is input into an image-to-image translation network 332 along with a shape normal map 324, 330. The diffuse albedo 316 map may be pre-processed before being input to the image-to-image translation network 320. For example, the diffuse albedo map 316 may be converted to greyscale diffuse albedo map, as described above in relation to the specular albedo map 322. The shape normal map may be the shape normal map in tangent space 330, N_{T}.

The specular normal image-to-image translation network 332 processes its inputs through a plurality of layers and outputs a specular normal map 334. In embodiments where a shape normal map in tangent space is input and the diffuse albedo map is converted to greyscale, this may be represented symbolically as:

N_{S}=ρ(A_{D}^{gray},N_{T})

where: A_{D}^{gray},N_{O}→N_{D}∈ [symbol] ^{H}^{_{Ns}}^{×W}^{_{Ns}}^{×3}, with H_{Ns} and W_{NsD} the height and width of the specular normal map 334 respectively. In some embodiments, H_{Ns} and W_{Ns} are equal to H_{D} and W_{D} respectively. The generated 2D specular normal map 334 may be a UV map. In some embodiments, the specular normal map 334 is passed through a high-pass filter to constrain it to tangent space.

The generated 2D specular normal map 334 is used to render the 3D facial model 318, along with the diffuse albedo map 316 and the 3D model 308 of the geometry of the face. The 2D specular albedo map 322 and/or diffuse normal map 328 may additionally be used.

The inferred normals (i.e. N_{D} and Nₛ) can be used to enhance the base reconstructed geometry by refining its med-frequency and adding plausible high-frequency details. The specular normals 334 may be integrated over in tangent space to produce a detailed displacement map which can then be embossed on a subdivided base geometry.

A high resolution 3D facial model 318 is generated from the 3D model 308 of the geometry of the face and one or more of the 2D maps 316, 322, 328, 334.

In some embodiments, an entire head model may be generated from the facial model 318. The facial mesh may be projected onto a subspace, and latent head parameters regressed based on a learned regression matrix that performs an alignment between subspaces. An example of such a model is the Combined Face and Head model described in “Combining 3d morphable models: A large scale face-and-head model” (S. Ploumpis et al., Proceedings of the IEEE Conference on Computer Vision and Pattern Recognition, pages 10934-10943, 2019), the contents of which are incorporated herein by reference.

FIG. 4 shows a schematic overview of a method 400 a training an image-to-image translation network. An input 2D map 402 (and, in some embodiments, a 2D normal map 404), s, from a training dataset is input into a generator neural network 406, G. The generator neural network 406 generates a transformed 2D map 408, G(s), from the input 2D map 402 (and, in some embodiments, the 2D normal map 404). The input 2D map 402 and the transformed 2D map 408 are input into a discriminator neural network 410, D, to generate a score 412, D(s, G(s)), indicating how plausible the discriminator 410 finds the transformed 2D map 408. The input 2D map 402 and a corresponding ground truth transformed 2D map 414, x, are also input into the discriminator neural network 410 to generate a score 412, D(s, x), indicating how plausible the discriminator 410 finds the ground truth transformed 2D map 414. Parameters of the discriminator 410 are updated based on a discriminator objective function 416, [symbol] _{D}, comparing of these scores 412. Parameters of the generator 406 are updated based on a generator objective function 418, [symbol] _{G}, that compares these scores 412 and also compares the generated transformed 2D map 408 to the ground truth transformed 2D map 414. The process may be iterated over the training dataset until a threshold condition, such as a threshold number of training epochs or equilibrium between the generator 406 and discriminator 410 being reached, it satisfied. Once trained, the generator 406 may be used an image-to-image translation network.

The training dataset comprises a plurality of training examples 420. The training dataset may be divided into a plurality of training batches, each comprising a plurality of training examples. Each training example comprises an input 2D map 402 and a corresponding ground truth transformed 2D map 414 of the input 2D map 402. The type of input 2D map 402 and the type of ground truth transformed 2D map 414 in the training example depends on the type of image-to-image translation network 406 being trained. For example, if a delighting image-to-image translation network is being trained, the input 2D map 402 is a high resolution texture map and the ground truth transformed 2D map 414 is a ground truth diffuse albedo map. If a specular albedo image-to-image translation network is being trained, the input 2D map 402 is a diffuse albedo map (or a greyscale diffuse albedo map) and the ground truth transformed 2D map 414 is a ground truth specular albedo map. If a diffuse normal image-to-image translation network is being trained, the input 2D map 402 is a diffuse albedo map (or a greyscale diffuse albedo map) and the ground truth transformed 2D map 414 is a ground truth diffuse normal map. If a specular normal image-to-image translation network is being trained, the input 2D map 402 is a diffuse albedo map (or a greyscale diffuse albedo map) and the ground truth transformed 2D map 414 is a ground truth specular normal map.

Each training example may further comprise a normal map 404 corresponding to an image from which the input 2D map 402 was derived. The normal map 404 may be a normal map in object space or a normal map in tangent space. The normal map 404 may be jointly input to the generator neural network 406 with the input 2D map to generate the transformed 2D map 408. In some embodiments it may also be jointly input into the discriminator neural network 410 when determining the plausibility score 412. In some embodiments the normal map is input into the generator neural network 406, but not the discriminator neural network 410.

The training examples may be captured using any method known in the art. For example, the training examples may be captured from subjects under illumination by a polarised LED sphere using the method described in “Multiview face capture using polarized spherical gradient illumination” (A. Ghosh et al., ACM Transactions on Graphics (TOG), volume 30, page 129. ACM, 2011) to capture high resolution pore-level geometry and reflectance maps of faces. Half the LEDs on the sphere may be vertically polarized (for parallel polarization), and the other half may be horizontally polarized (for cross-polarization) in an interleaved pattern. Using the LED sphere, a multi-view facial capture method, such as the method described in “Multi-view facial capture using binary spherical gradient illumination” (A. Lattas et al., ACM SIGGRAPH 2019 Posters, page 59. ACM, 2019), may be used which separates the diffuse and specular components based on colour-space analysis. These methods produce very clean results, and require much less data capture (hence reduced capture time) and have a simpler setup (no polarizers) than other methods, enabling a large dataset to be captured.

To generate ground truth diffuse albedo maps, the illumination conditions of the dataset may be modelled using a cornea model of the eye and then 2D maps with the same illumination may be synthesized in order to train an image-to-image translation network from texture with baked-illumination to un-lit diffuse albedo. Using a cornea model of the eye, the average directions of the three point light sources with respect to the subject are determined. An environment map for the textures is also determined. The environment map produces a good estimation of the colour of the scene, while the three light sources help to simulate the highlights. A physically-based rendering for each captured subject from all view-points is generated using the predicted environment map and the predicted light sources (optionally with a random variation of their position), and produce an illuminated (normalised) texture map. The simulation process may be represented symbolically as: ξ: A_{D}∈ [symbol] ^{H×W×3}→A_{D}^{T}∈ [symbol] ^{H×W×3}, which translate diffuse albedo to the distribution of textures of [14] as shown in the following:

A_{D}^{T}=ξ(A_{D})˜ [symbol] _{t∈{T}_{₁}_{,T}_{₂}_{, . . . ,T}_{ₙ}}.

The generator 406 may have a U-net architecture. The discriminator 410 may be a convolutional neural network. The discriminator 410 may have a fully convolutional architecture.

The discriminator neural network 410 is trained using a discriminator objective function 416, [symbol] _{D}, which compares scores 412 generated by the discriminator 410 from training examples, {s, x}, to scores 412 generated by the discriminator 410 from the output of the discriminator, {s, G(x)}. The discriminator objective function 416 may be based on a difference between expectation values of these scores taken over a training batch. An example of such a loss function is:

[symbol]

_{GAN}= [symbol] _{(s,x)}[log D(s,x)]+ [symbol] ₛ[log(1−D(s,G(s)))].

An optimisation procedure, such as stochastic gradient descent or an Adam optimisation algorithm (e.g. with β₁=0.5 and β₂=0.999), may be applied to the discriminator objective function 416 with the aim of maximising the objective function to determine the parameter updates.

The generator neural network 406 is trained using a generator objective function 418, [symbol] _{G}, which compares scores 412 generated by the discriminator 410 from training examples, {s, x}, to scores 412 generated by the discriminator 410 from the output of the discriminator, {s, G(x)}. The generator objective function 418 may comprise a term comparing scores 412 generated by the discriminator 410 from training examples, {s, x}, to scores 412 generated by the discriminator 410 from the output of the discriminator 410, {s, G(x)} (i.e. may contain a term identical to the discriminator loss 416). For example, the generator objective function 418 may comprise the term [symbol] _{GAN}. The generator objective function 418 may further comprise a term comparing the transformed 2D map 408 to the ground truth transformed 2D map 414. For example, the generator objective function 418 may comprise a norm (such as an L1 or L2 norm) of the difference between the transformed 2D map 408 and the ground truth transformed 2D map 414. An optimisation procedure, such as stochastic gradient descent or an Adam optimisation algorithm (e.g. with (β₁=0.5 and β₂=0.999), may be applied to the discriminator objective function 418 with the aim of minimising the objective function to determine the parameter updates.

During training, the high resolution data may be split into patches (for example, of size 512×512 pixels) in order to augment the number of data sample and avoid overfitting. For example, using a stride of a given size (e.g. 128 pixels), partly overlapping patches may be derived by passing through each original 2D map (e.g. UV map) horizontally as well as vertically. The patch-based approach may also help overcome hardware limitations (for example, some high resolution images are not feasible to process through even by a 32 GB memory Graphics Card).

As used herein, the term neural network is preferably used to connote model comprising a plurality of layers of nodes, each node associated with one or more parameters. The parameters of each node of a neural network may comprise one or more weights and/or biases. The nodes take as input one or more outputs of nodes in a previous layer of the network (or values of the input data in an initial layer). The one or more outputs of nodes in the previous layer are used by a node to generate an activation value using an activation function and the parameters of the neural network. One or more of the layers of a neural network may be convolutional layers, each configured to apply one or more convolutional filters. One or more of the layers of a neural network may be fully connected layers. A neural network may comprise one or more skip connections.

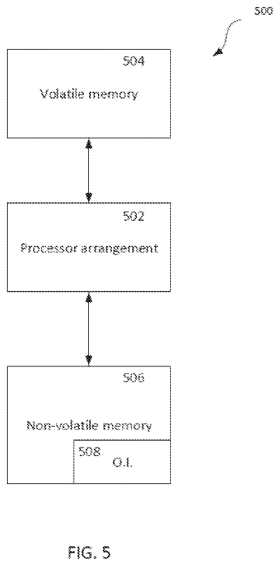

FIG. 5 shows a schematic example of a system/apparatus for performing any of the methods described herein. The system/apparatus shown is an example of a computing device. It will be appreciated by the skilled person that other types of computing devices/systems may alternatively be used to implement the methods described herein, such as a distributed computing system.

The apparatus (or system) 500 comprises one or more processors 502. The one or more processors control operation of other components of the system/apparatus 500. The one or more processors 502 may, for example, comprise a general purpose processor. The one or more processors 502 may be a single core device or a multiple core device. The one or more processors 502 may comprise a Central Processing Unit (CPU) or a graphical processing unit (GPU). Alternatively, the one or more processors 502 may comprise specialised processing hardware, for instance a RISC processor or programmable hardware with embedded firmware. Multiple processors may be included.

The system/apparatus comprises a working or volatile memory 504. The one or more processors may access the volatile memory 504 in order to process data and may control the storage of data in memory. The volatile memory 504 may comprise RAM of any type, for example Static RAM (SRAM), Dynamic RAM (DRAM), or it may comprise Flash memory, such as an SD-Card.

The system/apparatus comprises a non-volatile memory 506. The non-volatile memory 606 stores a set of operation instructions 508 for controlling the operation of the processors 502 in the form of computer readable instructions. The non-volatile memory 506 may be a memory of any kind such as a Read Only Memory (ROM), a Flash memory or a magnetic drive memory.

The one or more processors 502 are configured to execute operating instructions 508 to cause the system/apparatus to perform any of the methods described herein. The operating instructions 508 may comprise code (i.e. drivers) relating to the hardware components of the system/apparatus 500, as well as code relating to the basic operation of the system/apparatus 500. Generally speaking, the one or more processors 502 execute one or more instructions of the operating instructions 508, which are stored permanently or semi-permanently in the non-volatile memory 506, using the volatile memory 504 to temporarily store data generated during execution of said operating instructions 508.

Implementations of the methods described herein may be realised as in digital electronic circuitry, integrated circuitry, specially designed ASICs (application specific integrated circuits), computer hardware, firmware, software, and/or combinations thereof. These may include computer program products (such as software stored on e.g. magnetic discs, optical disks, memory, Programmable Logic Devices) comprising computer readable instructions that, when executed by a computer, such as that described in relation to FIG. 5, cause the computer to perform one or more of the methods described herein.

Any system feature as described herein may also be provided as a method feature, and vice versa. As used herein, means plus function features may be expressed alternatively in terms of their corresponding structure. In particular, method aspects may be applied to system aspects, and vice versa.

Furthermore, any, some and/or all features in one aspect can be applied to any, some and/or all features in any other aspect, in any appropriate combination. It should also be appreciated that particular combinations of the various features described and defined in any aspects of the invention can be implemented and/or supplied and/or used independently.

Although several embodiments have been shown and described, it would be appreciated by those skilled in the art that changes may be made in these embodiments without departing from the principles of this disclosure, the scope of which is defined in the claims.

1. A method comprising:
generating a three-dimensional shape model of a facial image and a low-resolution two-dimensional texture map of the facial image from a two-dimensional image using one or more fitting neural networks, wherein the two-dimensional image comprises the facial image;
applying a super-resolution model to the low-resolution two-dimensional texture map to generate a high-resolution two-dimensional texture map;
generating, from the high-resolution two-dimensional texture map and using a de-lighting image-to-image translation neural network, a two-dimensional diffuse albedo map; and
rendering, using the two-dimensional diffuse albedo map and the three-dimensional shape model, a high-resolution three-dimensional model of the facial image.

2. The method of claim 1, wherein the two-dimensional diffuse albedo map comprises a high-resolution two-dimensional diffuse albedo map.

3. The method of claim 1, further comprising:
determining, from the three-dimensional shape model, a two-dimensional normal map of the facial image; and
further generating, using the two-dimensional normal map, the two-dimensional diffuse albedo map.

4. The method of claim 1, comprising:
generating, using a specular albedo image-to-image translation neural network, from the two-dimensional diffuse albedo map, a two-dimensional specular albedo map; and
further rendering, based on the two-dimensional specular albedo map, the high-resolution three-dimensional model.

5. The method of claim 4, further comprising:
generating, from the two-dimensional diffuse albedo map, a grey-scale two-dimensional diffuse albedo map; and
inputting, into the specular albedo image-to-image translation neural network, the grey-scale two-dimensional diffuse albedo map.

6. The method of claim 4, further comprising:
determining, from the three-dimensional shape model, a two-dimensional normal map of the facial image; and
further generating, from the two-dimensional normal map, the two-dimensional specular albedo map.

7. The method of claim 1, further comprising:
determining, from the three-dimensional shape model, a two-dimensional normal map of the facial image;
generating, using a specular normal image-to-image translation neural network, from the two-dimensional diffuse albedo map and the two-dimensional normal map, a two-dimensional specular normal map; and
further rendering, based on the two-dimensional specular normal map, the high-resolution three-dimensional model.

8. The method of claim 7, further comprising:
generating, from the two-dimensional diffuse albedo map, a grey-scale two-dimensional diffuse albedo map; and
inputting, into the specular normal image-to-image translation neural network, the grey-scale two-dimensional diffuse albedo map and the two-dimensional normal map.

9. The method of claim 8, wherein the two-dimensional normal map is in a tangent space.

10. The method of claim 1, further comprising:
determining, from the three-dimensional shape model, a first two-dimensional normal map in an object space of the facial image;
generating, using a diffuse normal image-to-image translation neural network, from the two-dimensional diffuse albedo map and a second two-dimensional normal map in a tangent space, a two-dimensional diffuse normal map; and
further rendering, based on the two-dimensional diffuse normal map, the high-resolution three-dimensional model.

11. The method of claim 10, further comprising:
generating, from the two-dimensional diffuse albedo map, a grey-scale two-dimensional diffuse albedo map; and
inputting, into the diffuse normal image-to-image translation neural network, the grey-scale two-dimensional diffuse albedo map and the second two-dimensional normal map.

12. The method of claim 1, further comprising:
dividing each of the low-resolution two-dimensional texture map, the high-resolution two-dimensional texture map, and the two-dimensional diffuse albedo map into a plurality of overlapping input patches;
generating, for each of the overlapping input patches, using the de-lighting image-to-image translation neural network, an output patch; and
generating a full output two-dimensional map by combining a plurality of output patches.

13. The method of claim 1, wherein the one or more fitting neural networks and the de-lighting image-to-image translation neural network are generative adversarial networks.

14. The method of claim 1, further comprising generating, from the high-resolution three-dimensional model, and using a combined face and head model, a three-dimensional model of a head.

15. The method of claim 1, wherein of the low-resolution two-dimensional texture map, the high-resolution two-dimensional texture map, or the two-dimensional diffuse albedo map comprises an ultra violet (UV) map.

16.-17. (canceled)

18. A terminal device comprising:
a memory configured to store instructions; and
a processor coupled to the memory, wherein when executed by the processor, the instructions cause the terminal device to:
generate a three-dimensional shape model of a facial image and a low-resolution two-dimensional texture map of the facial image from a two-dimensional image using one or more fitting neural networks, wherein the two-dimensional image comprises the facial image;
apply a super-resolution model to the low-resolution two-dimensional texture map to generate a high-resolution two-dimensional texture map;
generate, from the high-resolution two-dimensional texture map, using a de-lighting image-to-image translation neural network, a two-dimensional diffuse albedo map; and
render, using the two-dimensional diffuse albedo map and the three-dimensional shape model, a high-resolution three-dimensional model of the facial image.

19. The terminal device of claim 18, wherein when executed by the processor, the instructions further cause the terminal device to:
determine, from the three-dimensional shape model, a two-dimensional normal map of the facial image; and
further generate, using the two-dimensional normal map, the two-dimensional diffuse albedo map.

20. A computer program product comprising computer-executable instructions that are stored on a non-transitory computer-readable storage medium and that, when executed by a processor, cause an electronic device to:
generate a three-dimensional shape model of a facial image and a low-resolution two-dimensional texture map of the facial image from a two-dimensional image using one or more fitting neural networks, wherein the two-dimensional image comprises the facial image;
apply a super-resolution model to the low-resolution two-dimensional texture map to generate a high-resolution two-dimensional texture map;
generate, from the high-resolution two-dimensional texture map and using a de-lighting image-to-image translation neural network, a two-dimensional diffuse albedo map; and
render, using the two-dimensional diffuse albedo map and the three-dimensional shape model, a high-resolution three-dimensional model of the facial image.

21. The method of claim 1, wherein the one or more fitting neural networks are generative adversarial networks.

22. The method of claim 1, wherein the de-lighting image-to-image translation neural network is a generative adversarial network.
